(19) United States
(12) Patent Application Publication
(10) Pub. No.: US 2020/0126008 A1
(43) Pub. Date: Apr. 23, 2020

(54) SYSTEM AND METHOD FOR SELECTIVELY PROVIDING ACCESS TO JOBSITE-RELATED DATA

(71) Applicant: Caterpillar Paving Products Inc., Brooklyn Park, MN (US)

(72) Inventors: Jacob J. McAlpine, Otsego, MN (US); Dann J. Rawls, Dunlap, IL (US); John L. Marsolek, Watertown, MN (US)

(73) Assignee: Caterpillar Paving Products Inc., Brooklyn Park, MN (US)

(21) Appl. No.: 16/162,590

(22) Filed: Oct. 17, 2018

(51) Int. Cl. G06Q 10/06; G06F 17/30; G06F 21/62

(52) U.S. Cl. CPC G06Q 10/0631; G06F 21/62; G06F 17/3089

(57) ABSTRACT

A system to facilitate selectively providing access to information associated with a paving operation may include a jobsite data management system. The jobsite data management system may include a processor configured to receive ticketing data from a first entity, and the ticketing data may include information associated with one or more loads of paving material supplied by the first entity. The processor may also be configured to provide access for a second entity to submit a request for approval to access the ticketing data. The processor may also be configured to provide access for the first entity to either grant access or deny access by the second entity to at least a portion of the ticketing data. The processor may further be configured to provide access to at least a portion of the ticketing data to the second entity.

### TECHNICAL FIELD

The present disclosure relates to a system and method for selectively providing access to information associated with a jobsite, and more particularly, for selectively providing access to information associated with a paving operation.

### BACKGROUND

An operation at a jobsite may involve the work of several entities operating with one another in a coordinated manner. Such coordination may be improved by the sharing of information by the different entities. However, because one or more of the entities may not be owned or controlled by a common entity, entities may be reluctant to share information with one another without maintaining at least partial control over the entities with which the information is shared, and/or the type of information shared with other entities.

For example, a paving operation may involve the work of several entities including, for example, an entity operating a paving material plant for preparing and supplying paving material, an entity operating one or more haul trucks for receiving a load of paving material from the paving material plant and transporting it to a paving jobsite, and an entity operating one or more paving machines for distributing the paving material on a surface at the paving jobsite. A paving operation is a substantially continuous operation, and it is often important to supply the paving material in a substantially continuous manner to the one or more paving machines, such that the paving machines can distribute the paving material in a substantially continuous manner, for example, to avoid seems in the resulting pavement surface. In addition, it may be important to prevent the back-up of haul trucks containing paving material, for example, to prevent the paving material from cooling, such that the resulting pavement surface is adversely affected. As a result, coordination of work between the paving material plant operator, haul truck operator, and/or paving machine operator may be important for obtaining a finished pavement surface having desired characteristics. However, in many instances, one or more of the paving material plant operator, the haul truck operator, or the paving machine operator may be unrelated entities, and thus, sharing of information may be compromised.

An attempt to provide a secure data exchange system is described in U.S. Patent Application Publication No. US 2015/0163206 A1 (“the '206 publication”) to McCarthy et al., published Jun. 11, 2015. Specifically, the '206 publication describes a purportedly secure data exchange system that includes a data management facility and data storage nodes. According to the '206 publication, the data management facility manages content sharing between entities of data stored in the data storage nodes, the data being stored by a user of a first entity and includes content and metadata. The data management facility only has access to the metadata of the user data for managing of the data in the data storage nodes and not to the content. According to the '206 publication, the data management facility may be geographically distributed at data management sites, and the data storage nodes may exist inside and outside of a firewall of the first entity.

Although the system of the '206 publication purports to provide a secure data exchange system, it does not provide an ability for one or more of the entities to grant or deny access to data related to their respective operations. Thus, system of the '206 publication may not be useful in situations such as those noted above.

The system and method disclosed herein may be directed to mitigating or overcoming one or more of the possible drawbacks set forth above.

### SUMMARY

According to a first aspect, a system to facilitate selectively providing access to information associated with a paving operation may include a jobsite data management system. The jobsite data management system may include a processor in communication with one or more communication networks, and the processor may be configured to receive ticketing data from a first entity via the one or more communication networks. The first entity may operate a paving material plant for preparing paving material, and the ticketing data may include information associated with one or more loads of paving material supplied by the first entity, such as, for example, material identification, loaded weight, jobsite identification, truck identification, etc. The processor may also be configured to provide access for a second entity in communication with the jobsite data management system to submit a request for approval to access the ticketing data. The second entity may operate one or more of a haul truck for transporting a load of paving material or a paving machine for distributing paving material onto a surface. The processor may also be configured to provide access for the first entity to one of grant access or deny access by the second entity to at least a portion of the ticketing data. The processor may further be configured to provide, based at least in part on the grant or denial of access by the second entity to at least a portion of the ticketing data, access to at least a portion of the ticketing data to the second entity.

According to a further aspect, a method for selectively providing access to information associated with a paving operation may include receiving ticketing data from a first entity. The first entity may operate a paving material plant for preparing paving material, and the ticketing data may include information associated with one or more loads of paving material supplied by the first entity. The method may also include receiving from a second entity a request for approval to access the ticketing data, and the second entity may operate one or more of a haul truck for transporting a load of paving material or a paving machine for distributing paving material onto a surface. The method may further include providing access for the first entity to one of grant access or deny access by the second entity to at least a portion of the ticketing data. The method may also include providing access, based at least in part on the grant or denial, to at least a portion of the ticketing data to the second entity.

According to another aspect, a computer-readable storage medium having computer-executable instructions stored thereupon which, when executed by a computer, may cause the computer to receive ticketing data from a first entity. The first entity may operate a paving material plant for preparing paving material, and the ticketing data may include information associated with one or more loads of paving material supplied by the first entity. The computer may be further caused to provide access for a second entity to submit a request for approval to access the ticketing data, and the second entity may operate one or more of a haul truck for transporting a load of paving material or a paving machine for distributing paving material onto a surface. The computer may be also caused to provide access for the first entity to one of grant access or deny access by the second entity to at least a portion of the ticketing data, and provide, based at least in part on the grant or denial of access by the second entity to at least a portion of the ticketing data, access to at least a portion of the ticketing data to the second entity.

### BRIEF DESCRIPTION OF THE DRAWINGS

The detailed description is described with reference to the accompanying figures. In the figures, the left-most digit or digits of a reference number identifies the figure in which the reference number first appears. The same reference numbers in different figures indicate similar or identical items.

FIG. 1 illustrates an example jobsite operation including an example system for selectively providing access to information associated with a paving operation.

FIG. 2 illustrates an example system for selectively providing access to information associated with a paving operation, including an example architecture for implementing the system and an example flow of information to and from an example jobsite data management system.

FIG. 3 is a depiction of example user interfaces of an example sequence for a paving material plant customer to request approval for ticketing data and location-related data via an example jobsite data management system.

FIG. 4 is depiction of an example user interface for requesting and granting or denying approval for access to ticketing data and/or location-related data.

FIG. 5 is a depiction of an example ticketing data display for showing example ticketing data.

FIG. 6 is a depiction of an example first location-related data display showing example location-related data associated with the status of an example paving operation.

FIG. 7 is a depiction of an example second location-related data display showing example location-related data associated with loads of paving material required to complete an example paving operation.

FIG. 8 is a depiction of an example third location-related data display showing example location-related data associated with locations of haul trucks involved with an example paving operation.

FIG. 9 is a depiction of an example fourth location-related data display showing example location-related data associated with an amount of paving material paved and an amount of paving material remaining to be paved for an example paving operation.

FIG. 10 is a depiction of an example fifth location-related data display showing example location-related data associated with example cycle times related to an example paving operation.

FIG. 11 is a block diagram of an example process for selectively providing access to information associated with a paving operation.

### DETAILED DESCRIPTION

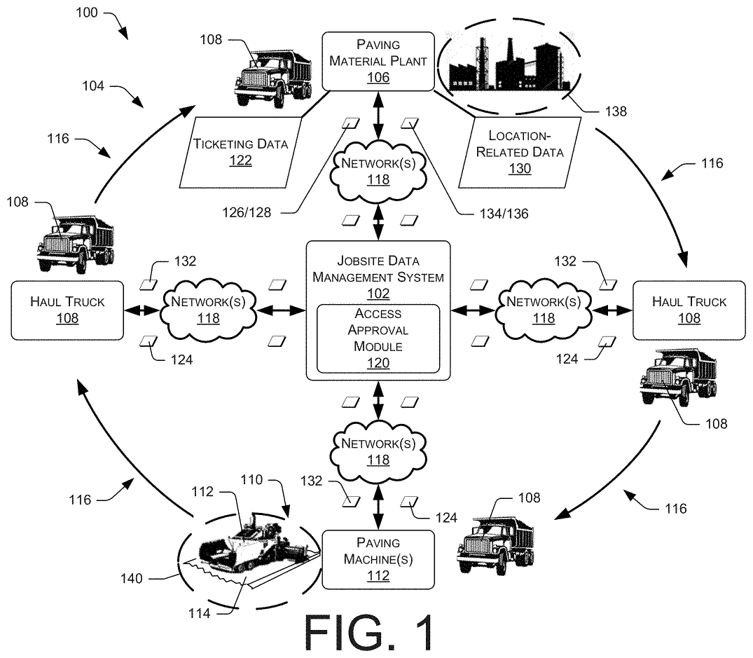

FIG. 1 illustrates a pictorial flow diagram of an example jobsite operation 100 and an example jobsite data management system 102 for facilitating the selective provision of access to information associated with the jobsite operation 100. The example jobsite operation shown in FIG. 1 is an example paving operation 104. Other types of jobsite operations are contemplated.

In the example shown in FIG. 1, the paving operation 104 includes a paving material plant 106 for preparing paving material. The paving material may be, for example, asphalt, heated asphalt, concrete, or any other material suitable for being distributed on a surface to provide a hardened surface suitable for pedestrian and/or vehicle traffic. The example paving operation 104 shown in FIG. 1 also includes one or more haul trucks 108 for receiving and transporting a load of paving material to a paving jobsite 110. As shown in FIG. 1, one or more paving machines 112 may be present at the paving jobsite 110, and the paving machines 112 may be configured to distribute paving material from the paving material plant 106 onto a surface 114 to provide a hardened surface suitable for pedestrian and/or vehicle traffic. The one or more paving machines 112 may be any type of paving machine suitable for distributing the paving material onto the surface 114.

As shown in FIG. 1, some examples of the paving operation 104 may operate according to an operation cycle 116. For example, the paving material plant 106 may operate to supply loads of paving material for use at the paving jobsite 110. One or more haul trucks 108 may be used to pick-up and deliver one or more loads of paving material to the one or more paving machines 112 at the paving jobsite 110, so that the paving machines 112 may receive the paving material and distribute it on the surface 114. After a haul truck 108 delivers the paving material, the haul truck 108, in some examples, may return to the paving material plant 106 to pick-up another load of paving material for transport to the paving jobsite 110 and the one or more paving machines 112, and to continue the cycle 116.

In this example manner, the paving operation 104 may be a substantially continuous operation, and it may be important to supply the paving material in a substantially continuous manner to the one or more paving machines 112, such that the paving machines 112 can distribute the paving material in a substantially continuous manner, for example, to avoid seems in the resulting pavement surface. In addition, it may be important to prevent the back-up of haul trucks 108 containing paving material, for example, to prevent the paving material from cooling, such that the resulting pavement surface is adversely affected. As a result, coordination of work between the operator of the paving material plant 106, the one or more operators of the haul trucks 108, and/or the one or more operators of the one or more paving machines 112 may be important for obtaining a finished pavement surface having desired characteristics. As noted above, however, in some instances, one or more of the operator of the paving material plant 106, the one or more operators of the haul trucks 108, and/or the one or more operators of the paving machines 112 may be unrelated entities, and thus, sharing of information between the entities, so that the paving operation 104 may be executed more efficiently, may be hindered.

The example jobsite data management system 102 shown in FIG. 1 may, in some examples, facilitate the selective provision of access to information associated with the paving operation 104, so that one or more entities associated with the paving operation 104 may share information and operate in a more efficient and coordinated manner, even when one or more of the entities are not commonly owned or operated. For example, the paving material plant 106 may be operated by a first entity, one or more of the haul trucks 108 may be operated by one or more second entities, and one or more or the paving machines 112 may be operated by one or more third entities. It is contemplated that one or more of the first, second, or third entities may be commonly owned and/or controlled, or that each of the first, second, and third entities may be independently owned and/or controlled.

In the example shown in FIG. 1, one or more of the paving material plant 106, the one or more haul trucks 108, or the one or more paving machines 112 may be in communication with the jobsite data management system 102 via one or more communication networks 118. The one or more communication networks 118 may include any type of network, such as a public wide-area-network (WAN) (e.g., the Internet), which may utilize various different technologies including wired and wireless technologies. The jobsite data management system 102 may include an access approval module 120 configured to facilitate selective access to data associated with the paving operation 104. For example, as explained in more detail herein, the jobsite data management system 102, including the access approval module 120, may be executed by one or more processors to facilitate selective access to data associated with the paving operation 104.

In some examples, the access approval module 120 may be in communication with the one or more communication networks 118, and the access approval module 120 may be configured to receive ticketing data 122 from a first entity associated with the paving material plant 106 via the one or more communication networks 118. As explained in more detail herein, the ticketing data 122 may include information associated with one or more loads of paving material supplied by the paving material plant 106, such as, for example, material identification, loaded weight, jobsite identification, truck identification, etc. The access approval module 120 may also be configured to provide access for a second entity associated with one or more of the haul trucks 108 and/or one or more of the paving machines 112 in communication with the jobsite data management system 102 via the one or more communication networks 118 to submit a request 124 for approval to access the ticketing data 122. In some examples, such access would be limited to access to ticketing data 122 received by the jobsite data management system 102 from the first entity associated with the paving material plant 106, for example, without direct communication between the first entity and the second entity associated with one or more of the haul trucks 108 and/or the paving machines 112. For example, the jobsite data management system 102 may include memory for storing the ticketing data 122, and the second entity may access the ticketing data 122 stored by the jobsite data management system 102. In some examples, the ticketing data 122 may be stored in memory associated with a system controlled by the first entity, and the second entity may access the ticketing data 122 from the memory at the first entity (e.g., at the paving material plant 106) via communication through the jobsite data management system 102, which may provide a communication conduit between the first entity and the second entity.

In some examples, the access approval module 120 may be configured to provide access for the first entity associated with the paving material plant 106 to either grant the request 124 for access or deny the request 124 for access by the second entity associated with the haul trucks 108 and/or paving machines 112 to at least a portion of the ticketing data 122. For example, the first entity may communicate either a grant 126 in response to the request 124, or communicate a denial 128 in response to the request 124, for approval of access by the second entity to at least a portion of the ticketing data 122. In such examples, the access approval module 120 may be configured to provide, based at least in part on the grant 126 or denial 128 of access by the second entity to at least a portion of the ticketing data 122, access to at least a portion of the ticketing data 122 to the second entity. For example, the first entity may, via the jobsite data management system 102, grant the access requested by the second entity, and the second entity may be able view at least a portion of the ticketing data 122 via a display device. On the other hand, the first entity may, via the jobsite data management system 102, deny the access requested by the second entity, and the second entity may thus be prevented from viewing any of the ticketing data 122. In this example manner, the jobsite data management system 102, via the access approval module 120, may enable the first entity to maintain at least partial control over the entities with which the ticketing data 122 is shared.

In some examples, the jobsite data management system 102 may be configured to provide access for a third entity in communication with the jobsite data management system 102 via one or more of the communication networks 118 to submit a request for approval to access the ticketing data 122. For example, the second entity may operate one or more of the haul trucks 108, and the third entity may operate one or more paving machines 112 for distributing paving material onto the surface 114. In such examples, the jobsite data management system 102 (e.g., the access approval module 120) may be configured to provide access for the first entity to either grant access or deny access by the third entity to at least a portion of the ticketing data 122, and provide, based at least in part on the grant or denial of access by the third entity to at least a portion of the ticketing data 122, access to at least a portion of the ticketing data 122 to the third entity.

In some examples, as explained herein, the request 124 for approval of access to the ticketing data 122 may include a unique customer identifier associated with the second entity and/or third entity. The customer identifier may include one or more of a letter-based code, a number-based code, or an alphanumeric code. As explained herein, the ticketing data 122, in some examples, may include one or more of an identifier associated with the first, second, and/or third entities, an identifier associated with one or more haul trucks 108, a paving project identifier, a material identifier, a customer identifier associated with one or more of the first, second, and/or third entities, or a weight associated with paving material loaded onto one or more of the haul trucks 108. Although these examples have explicitly mentioned first, second, and third entities for the purpose of explanation, it is contemplated that more than three entities may be involved in the paving operation 104, and the jobsite data management system 102, in some examples, may be configured to selectively provide access to any number of entities.

As shown in FIG. 1, following grant of access to the second and/or third entities to at least a portion of the ticketing data 122 by the first entity, in some examples, the jobsite data management system 102 may be configured to receive location-related data 130 associated with a load of paving material from the first entity via the one or more communication networks 118. In some examples, the location-related data 130 may include information associated with a location of a load of paving material supplied by the paving material plant 106 operated by the first entity, for example, as described herein. In some examples, the jobsite data management system 102 (e.g., the access approval module 120) may be configured to provide access for the second and/or third entities in communication via the one or more communication networks 118 with the jobsite data management system 102 to submit a request 132 for approval to access the location-related data 130. In some examples, the jobsite data management system 102 may be configured to provide access for the first entity to either of grant access or deny access by the second and/or third entities to at least a portion of the location-related data 130, and provide, based at least in part on the grant or denial of access by the second and/or third entities to at least a portion of the location-related data 130, access to at least a portion of the location-related data 130 to the second and/or third entities For example, the first entity may communicate either a grant 134 in response to the request 132, or communicate a denial 136 in response to the request 132, for approval of access by the second and/or third entities to at least a portion of the location-related data 130.

In such examples, the access approval module 120 may be configured to provide, based at least in part on the grant 134 or denial 136 of access by the second and/or third entities to at least a portion of the location-related data 130, access to at least a portion of the location-related data 130 to the second and/or third entities. For example, the first entity may, via the jobsite data management system 102, grant the access requested by the second and/or third entities, and the second and/or third entities may be able view at least a portion of the location-related data 130 via a display device. In contrast, the first entity may, via the jobsite data management system 102, deny the access requested by the second and/or third entities, and the second and/or third entities may thus be prevented from viewing any of the location-related data 130. In this example manner, the jobsite data management system 102, via the access approval module 120, may enable the first entity to maintain at least partial control over the entities with which the location-related data 130 is shared with other entities.

In some examples, the jobsite data management system 102 may be configured to prevent access (with or without approval by the first entity) by the second and/or third entities to the location-related data 130 until the second and/or third entities have already been granted access to the ticketing data 122. In other examples, the jobsite data management system 102 may be configured to permit access (e.g., with approval by the first entity) by the second and/or third entities to the location-related data 130, even if the second and/or third entities do not already have access to the ticketing data 122.

In some examples, a first geofence 138 may be associated with a first location at which loads of paving material are supplied by the first entity. For example, the first geofence 138 may be provided at the paving material plant 106. In some examples, the location-related data 130 may include time-related data associated with a first time at which a haul truck 108 enters the first geofence 138 and a second time at which the haul truck 108 exits the first geofence 138 with a load of the paving material. In some examples, a second geofence 140 may be associated with a second location at which loads of paving material are deposited at a paving machine 112. For example, the second geofence 140 may be provided at the one or more paving machines 112. In some examples, the location-related data 130 may include time-related data associated with a third time at which a haul truck 108 enters the second geofence 140 with the load of paving material, and, in some examples, the location-related data 130 may further include time-related data associated with a fourth time at which the haul truck 108 exits the second geofence 140. In some examples, the location-related data 130 may further include one or more of information representative of a number of haul trucks 108 in transit between the first location at which loads of paving material are supplied by the first entity (e.g., at the paving material plant 106) and a second location at which loads of paving material are deposited at one or more paving machines 112, an amount of paving material in transit between the first location and the second location, a cycle time associated with a haul truck 108, the cycle time including a time associated with the haul truck 108 receiving a first load of paving material at the first location, depositing the first load of paving material at the second location, and returning to the first location to accept a second load of paving material.

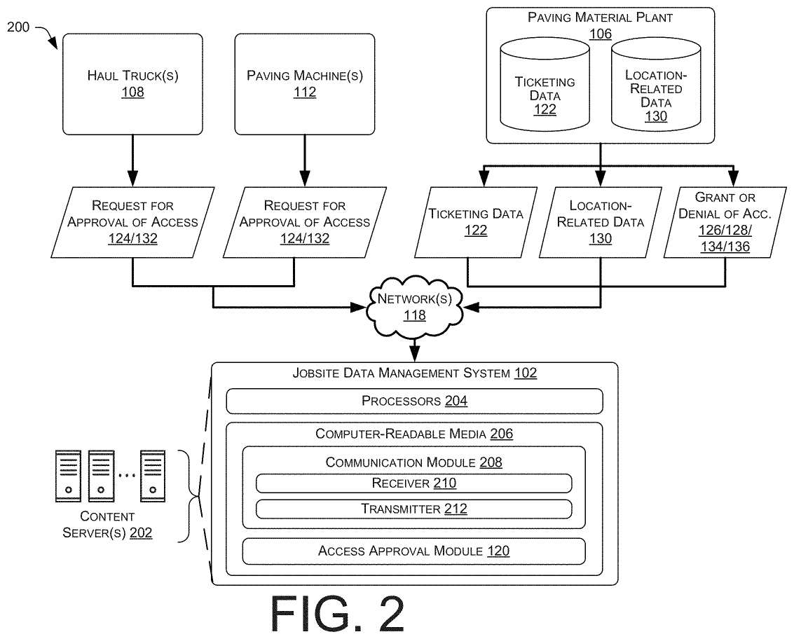

FIG. 2 illustrates an example jobsite operation 200 and an example jobsite data management system 102 for facilitating the selective provision of access to information associated with the jobsite operation 200, which may correspond to the example jobsite operation 100 shown in FIG. 1. As shown in FIG. 2, the example jobsite operation 200 is an example paving operation, and the jobsite operation 200 includes a paving material plant 106 for preparing paving material, one or more haul trucks 108 for receiving and transporting a load of paving material from the paving material plant 106 to the a paving jobsite, and one or more paving machines 112 configured to distribute paving material from the paving material plant 106 onto a surface to provide a hardened surface suitable for pedestrian and/or vehicle traffic.

As explained herein, the paving material plant 106, the one or more haul trucks 108, and/or the one or more paving machines 112 may be in communication with the jobsite data management system 102 via the one or more communication networks 118. The example jobsite data management system 102 shown in FIG. 2 includes an access approval module 120 configured to facilitate selective access to data associated with the paving operation 104. The jobsite data management system 102, including the access approval module 120, may be executed by one or more processors to facilitate selective access to data associated with the paving operation 104.

For example, as shown in FIG. 2, the jobsite data management system 102 includes one or more content server(s) 202. The one or more communication networks 118 may facilitate communications/interactions via any type of network, such as a public wide-area-network (WAN) (e.g., the Internet), which may utilize various different technologies including wired and wireless technologies. The content server(s) 202 may contain any number of servers that are possibly arranged as a server farm. Other server architectures may also be used to implement the content server(s) 202. As shown, the content server(s) 202 include the one or more processor(s) 204 and computer-readable media 206. In the example shown, the computer-readable media 206 includes a communication module 208 including a receiver 210 and a transmitter 212, and the access approval module 120.

The one or more processors 204 may execute the access approval module 120 and any other modules associated with the jobsite data management system 102 to cause the jobsite data management system 102 and/or the content servers 202 to perform a variety of functions, as set forth above and explained in further detail herein. In some examples, the processor(s) 204 may include a central processing unit (CPU), a graphics processing unit (GPU), both CPU and GPU, or other processing units or components known in the art. Additionally, each of the processors 204 may possess its own local memory, which also may store program modules, program data, and/or one or more operating systems.

The computer-readable media 206 may include volatile memory (e.g., RAM), non-volatile memory (e.g., ROM, flash memory, miniature hard drive, memory card, or the like), or some combination thereof. The computer-readable media 206 may be non-transitory computer-readable media. The computer-readable media 206 may include or be associated with the one or more of the above-noted modules, which perform various operations associated with the jobsite data management system 102 and/or the content server(s) 202. In some examples, one or more of the above-noted modules may include or be associated with computer-executable instructions that are stored by the computer-readable media 206 and that are executable by the one or more processors 204 to perform such operations. The jobsite data management system 102 and/or the content server(s) 202 may also include additional components not listed above that may perform any function associated with the jobsite data management system 102 and/or the content server(s) 202.

In some examples, the communication module 208 may be configured to facilitate communication of data between one or more of the paving material plant 106, the one or more haul trucks 108, and/or the one or more paving machines 112, and the jobsite data management system 102. For example, the communication module 208 may include a receiver 210 configured to receive one or more signals from one or more of the paving material plant 106, the one or more haul trucks 108, and/or the one or more paving machines 112 via, for example, the one or more communication networks 118. Such signals may include the ticketing data 122, the location-related data 130, the requests for approval of access 124/132, and/or the grant or denial of access 126/128/134/136 from one or more of the paving material plant 106, the one or more haul trucks 108, and/or the one or more paving machines 112. In some examples, for example, as shown in FIG. 2, the communications module 208 may include a transmitter 212 configured to transmit one or more signals via the one or more communication networks 118. Transmission of other data available to the jobsite data management system 102 is also contemplated. In some examples, the receiver 210 and the transmitter 212 may take the form of a transceiver.

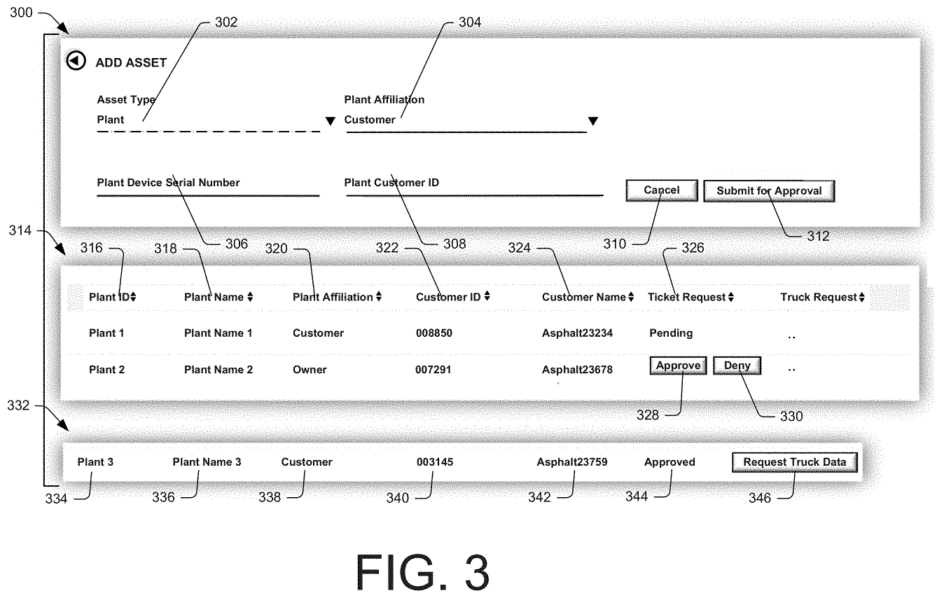

FIG. 3 is a depiction of example user interfaces (UIs) of an example sequence for a paving material plant customer to request approval for ticketing data and location-related data via an example jobsite data management system. In some examples, the access approval module 120 may be configured to generate one or more of the user interfaces in the sequence. As shown in FIG. 3, a first user interface 300 provides a customer of a paving material plant 106 (e.g., an entity associated with one or more haul trucks 108 and/or one or more paving machines 112) with an ability to request approval from the paving material plant 106 to obtain access to ticketing data 122 and/or location-related data 130 from the paving material plant 106. In the example user interface 300 shown, the entity is able to identify (1) the paving material plant from which the data is to be requested in a plant identifier field 302, (2) the affiliation with the paving material plant in an affiliation field 304, (3) the numeric identifier of the device or machine (e.g., a haul truck or paving machine) operated by the entity in the device identifier field 306, and (4) a unique customer identifier associated with the entity in the customer identifier field 308. As noted previously herein, the unique customer identifier may be a letter-based code, a number-based code, or an alphanumeric code. The example user interface 300 also includes a cancel button 310 for canceling the request and a submit button 312 for submitting the request.

As shown in FIG. 3, following submission of the request by the entity, a second user interface 314 is provided for the paving material plant operator to grant or deny the request for approval submitted via the first user interface 300. In the example shown, the second user interface 314 includes a plant identifier field 316 for identifying the paving material plant, a plant name field 318 for identifying the paving material plant name, a plant affiliation field 320 for identifying the paving material plant's relationship relative to the requesting entity, a customer identifier field 322 for uniquely identifying the requesting entity, a customer name field 324 for identifying the name of the requesting entity, and an approve/deny field 326 including an approve button 328 for approving the request for access to ticketing data 122 and a deny button 330 for denying the request for access to the ticketing data 122.

As shown in FIG. 3, if the paving material plant operator grants the entity's request for access to the ticketing data, in some examples, a third user interface 332 may be presented to the operator of the paving material plant and the entity to share location-related data 130. As shown, the example third user interface 332 includes a plant identifier field 334 for identifying the paving material plant, a plant name field 336 for identifying the name of the paving material plant, a plant affiliation field 338 for identifying the paving material plant's relationship relative to the requesting entity, a customer identifier field 340 for uniquely identifying the requesting entity, a customer name field 342 for identifying the name of the requesting entity, a ticketing data status field 344 for providing the status of the request for access to the ticketing data, and a request button 346 for requesting approval for access to location-related data 130. In some examples, if either the paving material plant operator or the entity requests approval for access to the location-related data 130, the other entity will be notified of the request, at which time the other entity will be able to grant or deny the request to share the location-related data 130.

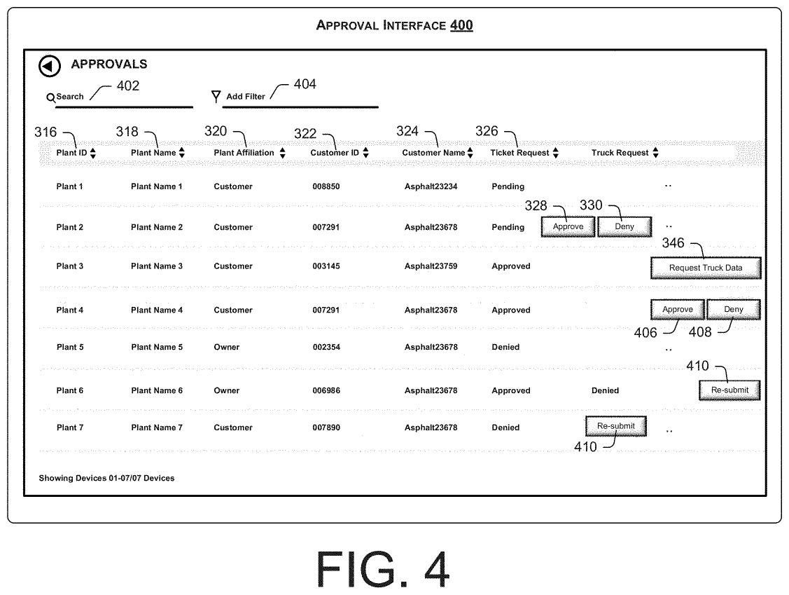

FIG. 4 is depiction of an example user interface 400 for requesting, granting, and/or denying approval for access to ticketing data 122 and/or location-related data 130. FIG. 4 shows an example approval interface 400, which may correspond to the second user interface 314 shown in FIG. 3. In addition, the example approval interface 400 includes a search field 402 for searching for desired results and a filter field 404 for filtering the information displayed on the approval interface 400. The example approval interface 400 also includes an approve button 406 and a deny button 408 for granting or denying approval for sharing the location-related data 130, and resubmit buttons 410 for resubmitting requests for approval for access to ticketing data 122 and location-related data 130, which were previously denied.

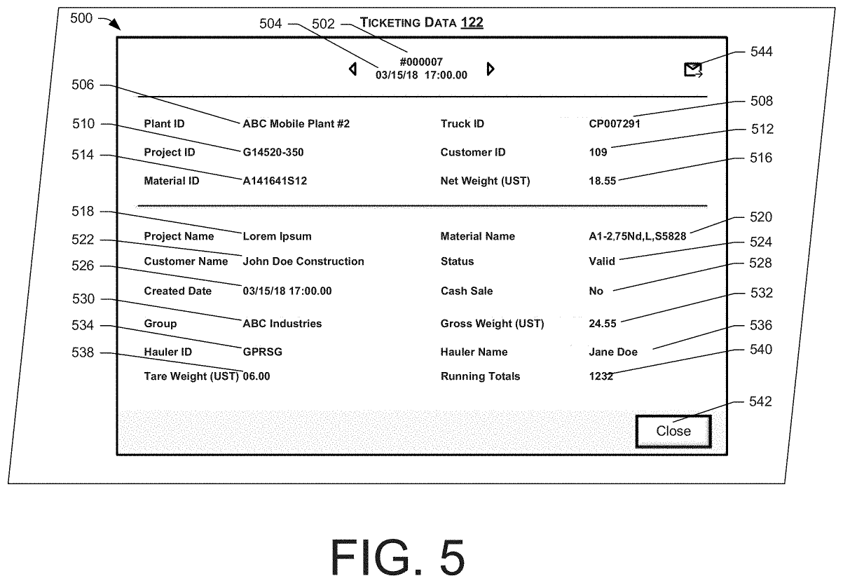

FIG. 5 is a depiction of an example ticketing data display 500 sowing an example of ticketing data 122. As shown in FIG. 5, the ticketing data 122 may include any information associated with one or more loads of paving material supplied by the paving material plant 106. In some examples, the entity operating the paving material plant 106 may generate the ticketing data 122 when a haul truck 108 receives a load of paving material. The ticketing data 122 may be communicated to the jobsite data management system 102.

In some examples, the ticketing data 122 may include one or more of the following information: a ticket number 502, a time stamp 504, identification of the paving material plant 506, identification of a haul truck 108 that received the load of paving material 508, a project identifier 510 associated with the paving operation 104 to which the load of paving material is to be delivered, a customer identifier 512 associated with the entity operating the haul truck 108, a material identifier 514 for identifying the load of material, a weight indicator 516 indicating the weight of the load of paving material, a project name 518 associated with the paving operation 104, a material name 520 associated with the paving material, a customer name 522 associated with the entity operating the haul truck 108 that received the load of paving material, a status 524 associated with the entity operating the haul truck 108, a creation time 526 (e.g., a date and time) associated with the load of paving material being received by the haul truck 108, a cash sale identifier 528 indicating whether the paving material was purchased with cash, a group identifier 530 associated with the entity or entities responsible for the paving operation 104, a total weight indication 532 associated with the combined weight of the load of paving material and the haul truck 108, a haul truck identifier 534 associated with the entity operating the haul truck 108, a hauler name 536 associated with the driver of the haul truck 108, a weight 538 associated with the haul truck 108 empty, and a running total 540 associated with the amount of paving material provided for the paving operation 104. In addition, the example ticketing data 122 shown in FIG. 5 includes a close button 542 for closing the ticketing data 122 and a mail button 544 for forwarding to the ticketing data 122 to another e-mail address.

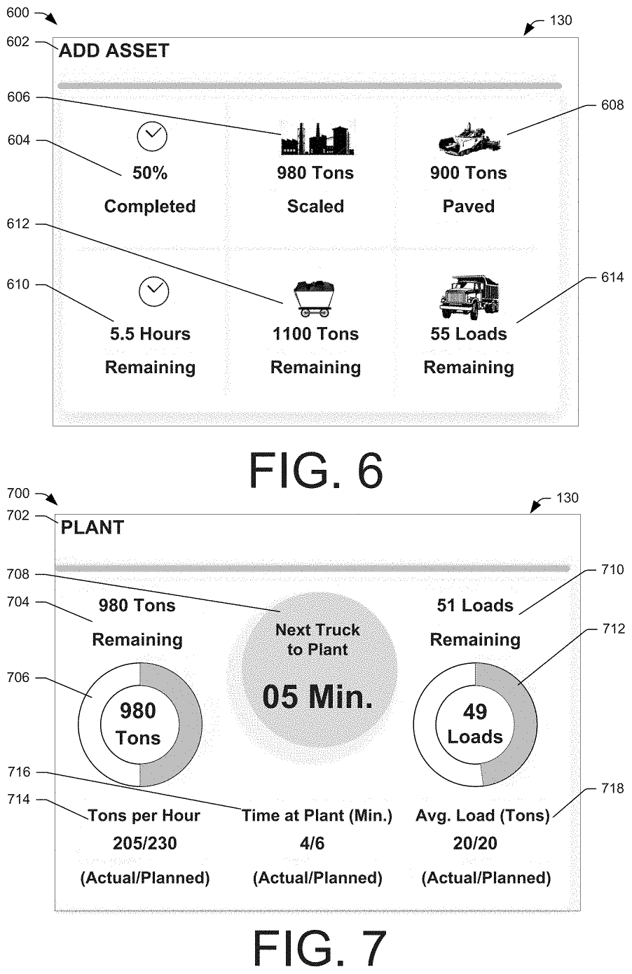

FIG. 6 is a depiction of an example first location-related data display 600 showing example location-related data 130 associated with the status of an example paving operation. The first location-related data display 600 is configured to display information related to the location-related data 130 associated with a paving operation 104. In some examples, the location-related data 130 may be generated, based in part, on one or more signals indicative of the location of various assets (e.g., devices and/or machines) and materials related to the paving operation 104. For example, the locations of one or more of the haul trucks 108 and/or one or more of the paving machines 112 may be determined and/or tracked as they operate in association with the paving operation 104. In some examples, the locations of one or more of the haul trucks 108 and/or paving machines 112 may be determined using a global positioning system (GPS), such as, for example, GPS transmitters carried by the haul trucks 108 and/or paving machines 112. Other methods of determining the locations of the haul trucks 108 and/or paving machines 112 are contemplated. In some examples, the locations of the haul trucks 108 and/or paving machines 112 may be determined relative to the first geofence 138 associated with the paving material plant 106 and/or the second geofence 140 associated with the paving jobsite 110. Thus, in some examples, the jobsite data management system 102 may maintain and/or update information related to when one or more of the haul trucks 108 is present at the paving material plant 106 and/or at the paving jobsite 110, for example, by receiving signals indicative of the haul trucks 108 entering and/or leaving the first geofence 138 and/or the second geofence 140. Other methods of determining whether the haul trucks 108 are present at the paving material plant 106 and/or at the paving jobsite 110 are contemplated.

In some examples, the location-related data 130 may include time-related data associated with a first time at which a haul truck 108 enters the first geofence 138 and a second time at which the haul truck 108 exits the first geofence 138 with a load of the paving material. In some examples, the location-related data 130 may include time-related data associated with a third time at which a haul truck 108 enters the second geofence 140 with the load of paving material, and, in some examples, the location-related data 130 may further include time-related data associated with a fourth time at which the haul truck 108 exits the second geofence 140. In some examples, the location-related data 130 may further include one or more of information representative of a number of haul trucks 108 in transit between the first location at which loads of paving material are supplied by the first entity (e.g., at the paving material plant 106) and a second location at which loads of paving material are deposited at one or more paving machines 112, an amount of paving material in transit between the first location and the second location, a cycle time associated with a haul truck 108, the cycle time including a time associated with the haul truck 108 receiving a first load of paving material at the first location, depositing the first load of paving material at the second location, and returning to the first location to accept a second load of paving material.

As shown in FIG. 6, the first location-related data display 600 includes a header 602 indicating the type of location-related data 130 being displayed. For example, the header 602 identifies the example location-related data 130 as being related to assets. The first location-related data display 600 also includes a percent completed field 604 associated with the portion of the paving operation 104 completed, a weight scaled field 606 associated with the amount of material weighed at the paving material plant 106, a weight paved field 608 showing the amount of paving material distributed at the paving jobsite 110, a time remaining field 610 showing the projected amount of time to complete the paving operation 104, an amount remaining field 612 associated with the projected amount of paving material needed to complete the paving operation 104, and the loads remaining field 614 associated with the projected number of loads of paving material required to complete the paving operation 104.

FIG. 7 is a depiction of an example second location-related data display 700 showing example location-related data 130 associated with loads of paving material required to complete an example paving operation 104. As shown in FIG. 7, the second location-related data display 700 includes a header 702 indicating the type of location-related data 130 being displayed. For example, the header 702 identifies the example location-related data 130 as being related to the paving material plant 106. The second location-related data display 700 also includes a weight remaining field 704 associated with the projected amount of paving material needed to complete the paving operation 104, an amount remaining graph 706 showing the projected amount of paving material for completion of the paving operation 104, a projected arrival field 708 showing the projected time for the next haul truck 108 to arrive at the paving material plant 106 to pick up a load of paving material, a loads remaining field 710 showing the projected number of loads needed to complete the paving operation 104, a loads remaining graph 712 graphically showing the projected number of loads remaining relative the number of loads already picked-up, the amount per hour remaining field 714 showing the projected amount of paving material to be produced per hour (both actual and planned), a time at plant field 716 showing the projected time for a haul truck 108 to be at the paving material plant 106 during pick-up of a load of paving material (both actual and planned), and an average load-size field 718 showing the average load-size of loads of paving material picked-up at the paving material plant 106.

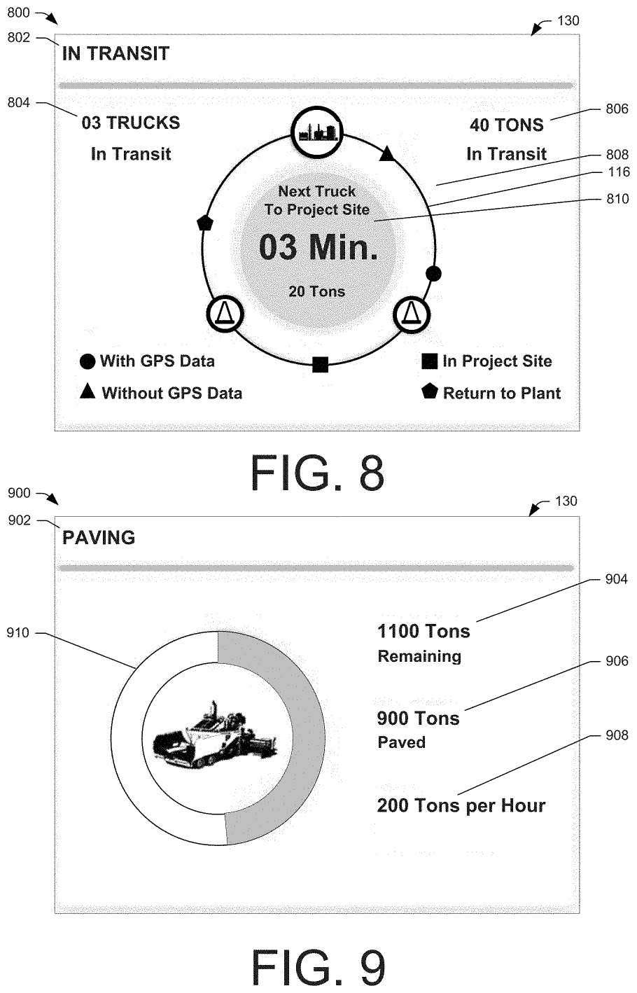

FIG. 8 is a depiction of an example third location-related data display 800 showing example location-related data 130 associated with locations of haul trucks 108 involved with an example paving operation. As shown in FIG. 8, the third location-related data display 800 includes a header 802 indicating the type of location-related data 130 being displayed. For example, the header 802 identifies the example location-related data 130 as being related to the paving material in transit from the paving material plant 106 to the paving jobsite 110 in a cycle 116 of the paving operation 104. The third location-related data display 800 also includes a trucks in transit field 804 showing the number of haul trucks 108 in transit, a weight in transit field 806 showing the weight of the paving material in transit, a cycle graph 808 graphically showing the locations of the haul trucks 108 relative to the cycle 116 of the paving operation 104, and a next truck to project site field 810 showing the projected time to arrival of the next haul truck 108 at the paving jobsite 110, including the projected time and the amount of paving material carried by the haul truck 108.

FIG. 9 is a depiction of an example fourth location-related data display 900 showing example location-related data 130 associated with an amount of paving material paved and an amount of paving material remaining to be paved for an example paving operation 104. As shown in FIG. 9, the fourth location-related data display 900 includes a header 902 indicating the type of location-related data 130 being displayed. For example, the header 902 identifies the example location-related data 130 as being related to the paving operation 104. The fourth location-related data display 900 also includes a projected paving remaining field 904 associated with the amount of paving material projected to be required to be distributed on the surface 114 for completion of the paving operation 104, a paving completed field 906 associated with the amount of paving material already distributed on the surface 114, an average paving rate field 908 associated with the average rate of distribution of the paving material, and a graph 910 graphically showing the amount of paving completed versus the projected amount of paving remaining to complete the paving operation 104.

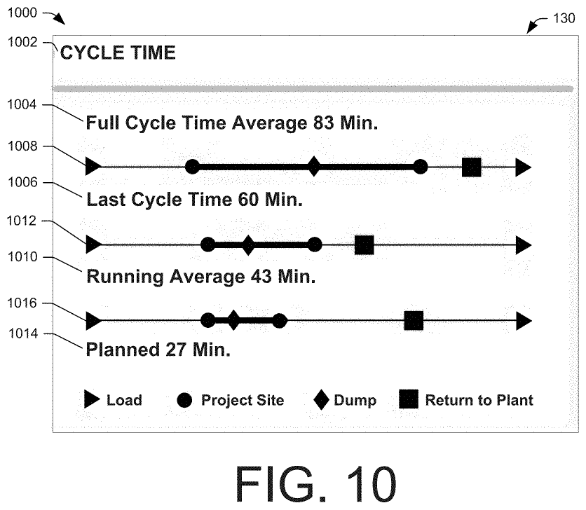

FIG. 10 is a depiction of an example fifth location-related data display 1000 showing example location-related data 130 associated with example cycle times related to an example paving operation 104. As shown in FIG. 10, the fifth location-related data display 1000 includes a header 1002 indicating the type of location-related data 130 being displayed. For example, the header 1002 identifies the example location-related data 130 as being related to the cycle times associated with the time for a haul truck 108 to complete a cycle 116 during the paving operation 104 as the haul truck 108 arrives at the paving material plant 106, receives a load of paving material, transports the load of paving material from the paving material plant 106 to the paving jobsite 110, dumps the load of paving material at the paving jobsite 110 (e.g., into one or more paving machines 112), and returns to the paving material plant 106 to complete the cycle 116 of the paving operation 104. In the example shown, the fifth location-related data display 1000 also includes an average cycle time field 1004 showing the average time for completing a full cycle 116 of the paving operation 104, a last cycle time field 1006 showing the cycle time of the most recent haul truck 108 to complete a cycle 116 including a bar graph 1008 graphically showing the relative times at various locations during the cycle 116, a running average field 1010 showing the running average for a haul truck 108 to complete a cycle 116 including a bar graph 1012 graphically showing the relative times at various locations during the cycle 116, and a planned cycle time field 1014 showing a target cycle time for completing a cycle 116 including a bar graph 1016 graphically showing the relative times at various locations during the cycle 116.

Although FIGS. 6-10 depict each of the location-related data displays separately, one or more of the location-related data displays may be displayed together on a single screen. In some examples, the jobsite data management system 102 may be configured to provide the ability for a user to select which location-related data displays are viewable together on a single screen.

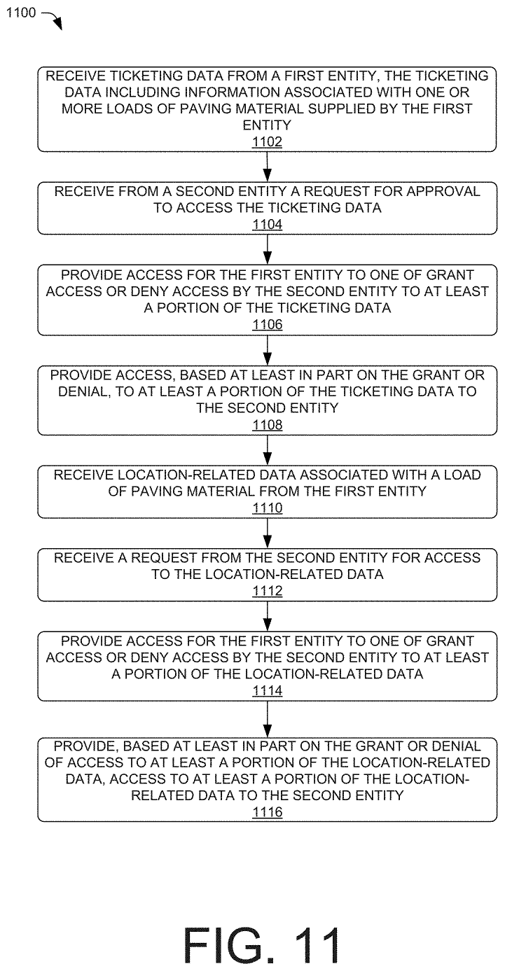

FIG. 11 illustrates an example process for selectively providing access to information associated with a paving operation. This process is illustrated as a logical flow graph, operation of which represents a sequence of operations, at least some of which may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 11 illustrates a flow diagram of an example process 1100 for selectively providing access to information associated with a paving operation, for example, as described herein. The following actions described with respect to FIG. 11 may be performed, for example, as illustrated with respect to FIGS. 1-10.

The example process 1100, at 1102, may include receiving ticketing data from a first entity. For example, the ticketing data may include information associated with one or more loads of paving material supplied by the first entity, where the first entity operates a paving material plant for preparing paving material. For example, the first entity may generate the ticketing data upon supply of a load of paving material to a haul truck operated by another entity, and the ticketing data may relate to the load of paving material. The ticketing data may be communicated via one or more communication networks to a jobsite data management system, for example, such as the jobsite data management system described herein. In some examples, the ticketing data may include one or more of an identifier associated with the first entity, an identifier associated with the haul truck, a paving project identifier, a material identifier, a customer identifier associated with the second entity, or a weight associated with material loaded onto the haul truck.

At 1104, the process 1100, in some examples, may include receiving from a second entity a request for approval to access the ticketing data. The second entity may operate one or more of a haul truck for transporting a load of paving material or a paving machine for distributing paving material onto a surface. In some examples, receiving the request may include receiving a unique customer identifier associated with the second entity, and the customer identifier may include one or more of a letter-based code, a number-based code, or an alphanumeric code. For example, the second entity may communicate the request via one or more communication networks to the jobsite data management system.

At 1106, the example process 1100 may include providing access for the first entity to either grant access or deny access by the second entity to at least a portion of the ticketing data. For example, the first entity may access the jobsite data management system via one or more communication networks, and the jobsite data management system may provide a user interface configured to enable the first entity to grant or deny the request from the second entity.

The example process 1100 may also include, at 1108, providing access, based at least in part on the grant or denial of access by the first entity, to at least a portion of the ticketing data to the second entity. For example, if access is granted by the first entity for the second entity to access the ticketing data, the jobsite management system may permit the second entity to view at least a portion of the ticketing data by facilitating communication of the ticketing data to the second entity for display viewable by the second entity.

At 1110, the example process 1100 may further include, for example, following grant of access by the second entity to at least a portion of the ticketing data from the first entity, receiving location-related data associated with a load of paving material from the first entity. The location-related data may include information associated with a location of a load of paving material supplied by the first entity. For example, the location-related data may include one or more of information representative of a number of haul trucks in transit between the first location at which loads of paving material are supplied by the first entity and a second location at which loads of paving material are deposited at a paving machine, an amount of paving material in transit between the first location and the second location, a cycle time associated with a haul truck, the cycle time including a time associated with the haul truck receiving a first load of paving material at the first location, depositing the first load of paving material at the second location, and returning to the first location to accept a second load of paving material, etc.

At 1112, the process 1100, in some examples, may further include receiving a request from the second entity for access to the location-related data. For example, the second entity may submit the request to the jobsite data management system via the one or more communication networks.

The process 1100, at 1114, may also include providing access for the first entity to either grant access or deny access by the second entity to at least a portion of the location-related data. For example, the first entity may access the jobsite data management system via the one or more communication networks, and the jobsite data management system may provide a user interface configured to enable the first entity to grant or deny the request from the second entity.

At 1116, the process 1100 may include providing, based at least in part on the grant or denial of access to at least a portion of the location-related data, access to at least a portion of the location-related data to the second entity. For example, if access is granted by the first entity for the second entity to access the location-related data, the jobsite management system may permit the second entity to view at least a portion of the location-related data by facilitating communication of the location-related data to the second entity for display viewable by the second entity.

### INDUSTRIAL APPLICABILITY

The example systems and methods of the present disclosure may be applicable to a variety of jobsites including jobsites involving more than a single entity operating multiple assets (e.g., machines and/or devices) in order to complete operations associated with the jobsite. For example, an operation at a jobsite may involve the work of several entities operating with one another in a coordinated manner. Such coordination may be improved by the sharing of information by the different entities. However, in many instances, one or more of the entities may be unrelated (e.g., one or more of the entities is/are independently owned or controlled), and thus, sharing of information may be hindered or unattractive to one or more of the entities. The systems and methods disclosed herein, in some examples, may facilitate sharing of such information by the different entities associated with the operation.

For example, a paving operation may involve the work of several entities including, for example, an entity operating a paving material plant for preparing and supplying paving material, an entity operating one or more haul trucks for receiving a load of paving material from the paving material plant and transporting it to a paving jobsite, and an entity operating one or more paving machines for distributing the paving material on a surface at the paving jobsite. Other entities are contemplated. A paving operation is a substantially continuous operation, and it may desirable to supply the paving material in a substantially continuous manner to the one or more paving machines, such that the paving machines can distribute the paving material in a substantially continuous manner, for example, to avoid seems in the resulting pavement surface. In addition, it may be important to prevent the back-up of haul trucks containing paving material at the paving jobsite, for example, to prevent the paving material from cooling, such that the resulting pavement surface is adversely affected. As a result, coordination of work between the paving material plant operator, the haul truck operator, and/or the paving machine operator may be important for obtaining a finished pavement surface having desired characteristics.

In some examples of the systems and methods described herein, one or more of the entities may be able share information with other entities related to a paving operation, while still maintaining at least partial control over the entities with which the information is shared, and/or the type of information shared with other entities. For example, an entity operating a paving material plant may be able to limit access to ticketing data associated with loads of paving material supplied by the paving material plant. For example, the paving material plant may generate ticketing data associated with a load of paving material when the paving material is loaded onto a haul truck. The ticketing data may be communicated to a jobsite data management system, for example, as described herein. An entity associated with the haul truck (and/or other entities associated with the paving operation) may access the jobsite data management system and enter, via a user interface, information indicative of a request for access to the ticketing data associated with the load of paving material. The first entity may access the jobsite data management system and via a user interface, grant or deny access by the entity associated with the haul truck (and/or the other entities associated with the paving operation) to the ticketing data, for example, as explained herein. In this example manner, the first entity may maintain control over the entities by which the ticketing data may be accessed.

As noted herein, in some examples, location-related data associated with one or more of the haul trucks may be generated and may be selectively available to one or more entities associated with a paving operation. For example, once an entity (or entities) has (or have) been granted access to ticketing data, the entity or entities may also request access to the location-related data via the jobsite data management system. For example, the one or more entities may request approval for access to the location-related data via a user interface generated by the jobsite data management system, for example, as described herein, and the first entity and/or or one or more entities associated with the paving operation may access the user interface to grant or deny approval for access to the location-related data. The location-related data may include information associated with the location of one or more haul trucks and/or paving machines associated with the paving operation, for example, relative to the paving material plant and/or the paving jobsite. The location-related data may also include time-related data associated with the locations of one or more of the assets related to the paving operation as well as well as additional data associated with the status of various aspects of the paving operation, for example, as described herein.

Some examples of the systems and methods described herein may improve the efficiency and reduce costs associated with a paving operation by facilitating the sharing of information (e.g., ticketing data and/or location-related data). For example, the systems and methods may facilitate the preparation and supply of paving material to a paving jobsite in a substantially continuous manner to the one or more paving machines, such that the paving machines can distribute the paving material in a substantially continuous manner, for example, to avoid seems in the resulting pavement surface. In addition, some examples of the systems and methods may reduce the likelihood of the back-up of haul trucks containing paving material at the paving jobsite, for example, to prevent the paving material from cooling, such that the resulting pavement surface is adversely affected. The systems and methods, in some examples, may improve the timeliness and efficiency of haul trucks arriving, loading, and departing with paving material supplied by the paving material plant, thereby improving the efficiency and timeliness of the paving operation.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A system to facilitate selectively providing access to information associated with a paving operation, the system comprising:
a jobsite data management system including a processor in communication with one or more communication networks, the processor configured to:
receive ticketing data from a first entity via the one or more communication networks, the ticketing data including information associated with one or more loads of paving material supplied by the first entity, the first entity operating a paving material plant for preparing paving material;
provide access for a second entity in communication with the jobsite data management system to submit a request for approval to access the ticketing data, the second entity operating one or more of a haul truck for transporting a load of paving material or a paving machine for distributing paving material onto a surface;
provide access for the first entity to one of grant access or deny access by the second entity to at least a portion of the ticketing data; and
provide, based at least in part on the grant or denial of access by the second entity to at least a portion of the ticketing data, access to at least a portion of the ticketing data to the second entity.

2. The system of claim 1, wherein the processor is further configured to:
provide access for a third entity in communication with the jobsite data management system to submit a request for approval to access the ticketing data, the third entity operating a paving machine for distributing paving material onto a surface;
provide access for the first entity to one of grant access or deny access by the third entity to at least a portion of the ticketing data; and
provide, based at least in part on the grant or denial of access by the third entity to at least a portion of the ticketing data, access to at least a portion of the ticketing data to the third entity.

3. The system of claim 1, wherein the request includes a unique customer identifier associated with the second entity, the customer identifier including one or more of a letter-based code, a number-based code, or an alphanumeric code.

4. The system of claim 1, wherein the ticketing data includes one or more of an identifier associated with the first entity, an identifier associated with a haul truck, a paving project identifier, a material identifier, a customer identifier associated with the second entity, or a weight associated with material loaded onto the haul truck.

5. The system of claim 1, wherein, following grant of access to the second entity to at least a portion of the ticketing data by the first entity, the processor is further configured to:
receive location-related data associated with a load of paving material from the first entity via the one or more communication networks, the location-related data including information associated with a location of a load of paving material supplied by the first entity;
provide access for the second entity in communication with the jobsite data management system to submit a request for approval to access the location-related data;
provide access for the first entity to one of grant access or deny access by the second entity to at least a portion of the location-related data; and
provide, based at least in part on the grant or denial of access by the second entity to at least a portion of the location-related data, access to at least a portion of the location-related data to the second entity.

6. The system of claim 5, further including a first geofence associated with a first location at which loads of paving material are supplied by the first entity, and wherein the location-related data includes time-related data associated with a first time at which a haul truck enters the first geofence and a second time at which the haul truck exits the first geofence with a load of the paving material.

7. The system of claim 6, further including a second geofence associated with a second location at which loads of paving material are deposited at a paving machine, and wherein the location-related data includes time-related data associated with a third time at which the haul truck enters the second geofence with the load of paving material.

8. The system of claim 7, wherein the location-related data further includes time-related data associated with a fourth time at which the haul truck exits the second geofence.

9. The system of claim 6, wherein the location-related data further includes one or more of information representative of a number of haul trucks in transit between the first location at which loads of paving material are supplied by the first entity and a second location at which loads of paving material are deposited at a paving machine, an amount of paving material in transit between the first location and the second location, a cycle time associated with a haul truck, the cycle time including a time associated with the haul truck receiving a first load of paving material at the first location, depositing the first load of paving material at the second location, and returning to the first location to accept a second load of paving material.

10. A method for selectively providing access to information associated with a paving operation, the method comprising:
receiving ticketing data from a first entity, the ticketing data including information associated with one or more loads of paving material supplied by the first entity, the first entity operating a paving material plant for preparing paving material;
receiving from a second entity a request for approval to access the ticketing data, the second entity operating one or more of a haul truck for transporting a load of paving material or a paving machine for distributing paving material onto a surface;
providing access for the first entity to one of grant access or deny access by the second entity to at least a portion of the ticketing data; and
providing access, based at least in part on the grant or denial, to at least a portion of the ticketing data to the second entity.

11. The method of claim 10, further including:
receiving a request from a third entity for approval to access the ticketing data, the third entity operating a paving machine for distributing paving material onto a surface;
providing access for the first entity to one of grant access or deny access by the third entity to at least a portion of the ticketing data; and
providing, based at least in part on the grant or denial of access by the third entity to at least a portion of the ticketing data, access to at least a portion of the ticketing data to the third entity.

12. The method of claim 10, wherein receiving the request includes receiving a unique customer identifier associated with the second entity, the customer identifier including one or more of a letter-based code, a number-based code, or an alphanumeric code.

13. The method of claim 10, wherein receiving the ticketing data includes receiving one or more of an identifier associated with the first entity, an identifier associated with a haul truck, a paving project identifier, a material identifier, a customer identifier associated with the second entity, a weight associated with material loaded onto the haul truck.

14. The method of claim 10, wherein, following grant of access by the second entity to at least a portion of the ticketing data from the first entity, the method further includes:
receiving location-related data associated with a load of paving material from the first entity, the location-related data including information associated with a location of a load of paving material supplied by the first entity;
receiving a request from the second entity for access to the location-related data;
providing access for the first entity to one of grant access or deny access by the second entity to at least a portion of the location-related data; and
providing, based at least in part on the grant or denial of access to at least a portion of the location-related data, access to at least a portion of the location-related data to the second entity.

15. The method of claim 14, wherein receiving the location-related data includes receiving information related to a first location at which loads of paving material are supplied by the first entity, the information related to the first location including time-related data associated with a first time at which a haul truck enters the first location and a second time at which the haul truck exits the first location with a load of the paving material.

16. The method of claim 15, wherein receiving the location-related data includes receiving information related to a second location at which loads of paving material are deposited at a paving machine, the information related to the second location including time-related data associated with a third time at which the haul truck enters the second location with the load of paving material.

17. The method of claim 15, wherein receiving the location-related data includes receiving one or more of information representative of a number of haul trucks in transit between the first location at which loads of paving material are supplied by the first entity and a second location at which loads of paving material are deposited at a paving machine, an amount of paving material in transit between the first location and the second location, a cycle time associated with a haul truck, the cycle time including a time associated with the haul truck receiving a first load of paving material at the first location, depositing the first load of paving material at the second location, and returning to the first location to accept a second load of paving material, depositing the load of paving material at the second location, and returning to the first location to accept a second load of paving material.

18. A computer-readable storage medium having computer-executable instructions stored thereupon which, when executed by a computer, cause the computer to:
receive ticketing data from a first entity, the ticketing data including information associated with one or more loads of paving material supplied by the first entity, the first entity operating a paving material plant for preparing paving material;
provide access for a second entity to submit a request for approval to access the ticketing data, the second entity operating one or more of a haul truck for transporting a load of paving material or a paving machine for distributing paving material onto a surface;
provide access for the first entity to one of grant access or deny access by the second entity to at least a portion of the ticketing data; and
provide, based at least in part on the grant or denial of access by the second entity to at least a portion of the ticketing data, access to at least a portion of the ticketing data to the second entity.

19. The computer-readable storage medium of claim 18, wherein following grant of access to the second entity to at least a portion of the ticketing data by the first entity, the computer is further caused to:
receive location-related data associated with a load of paving material from the first entity, the location-related data including information associated with a location of a load of paving material supplied by the first entity;
provide access for the second entity to submit a request for approval to access the location-related data;
provide access for the first entity to one of grant access or deny access by the second entity to at least a portion of the location-related data; and
provide, based at least in part on the grant or denial of access by the second entity to at least a portion of the location-related data, access to at least a portion of the location-related data to the second entity.

20. The computer-readable storage medium of claim 19, wherein the computer is further caused to receive information related to a first location at which loads of paving material are supplied by the first entity, the information related to the first location including time-related data associated with a first time at which a haul truck enters the first location and a second time at which the haul truck exits the first location with a load of the paving material.
